(19) United States
(12) Patent Application Publication
(10) Pub. No.: US 2009/0232860 A1
(43) Pub. Date: Sep. 17, 2009

(54) Colloidal metal-containing skin sanitizer

(76) Inventors: Brian G. Larson, Alpine, UT (US); Daryl J. Tichy, Orem, UT (US)

Correspondence Address: THORPE NORTH & WESTERN, LLP., P.O. Box 1219, SANDY, UT, 84091-1219, US

(21) Appl. No.: 12/231,312

(22) Filed: Aug. 29, 2008

Related U.S. Application Data
(60) Provisional application No. 60/967,040, filed on Aug. 30, 2007.

(51) Int. Cl. A01N 25/16; A01N 59/16; A01N 25/00; A01N 39/00; A01P 1/00

(52) U.S. Cl. 424/405; 424/618; 424/43; 424/642; 424/616; 424/613

(57) ABSTRACT

The present disclosure is drawn to disinfectant hand sanitizing compositions. In one embodiment, a hand sanitizing compositions can include from 10 to 1500 ppm colloidal silver, from 0.01 wt % to 30 wt % alcohol, at least 70 wt % water, and a thickening agent. The hand sanitizers can provide continued sanitization for an extended period of time and can be formulated to be dispensed as self-supporting foams.

This application claims the benefit of U.S. Provisional Application No. 60/967,040, filed Aug. 30, 2007, which is incorporated herein by reference.

### BACKGROUND

The spread of infectious diseases by contact with the skin, such as the hand, of an individual is a serious issue. Lack of hand sanitation is the core of the problem, and the appropriate sanitizing of the hands is the least expensive remedy to this vexing issue. Yet, it has been reported that hand washing compliance in some industries, (such as food handling, healthcare, etc.) does not exceed 40%. There are likely a variety of reasons for the low compliance including inconvenience, skin irritation, and/or skin cracking. Although conventional hand sanitizing formulations provide convenient hand sanitation, they too also frequently contribute to the problems of skin irritation and/or cracking. As such, research continues in the pursuit of developing effective hand sanitizing formulations that are easy and convenient to use and that do not cause skin irritation and/or cracking.

### DETAILED DESCRIPTION OF EXAMPLE EMBODIMENT(S)

Reference will now be made to the exemplary embodiments, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention. It is also to be understood that the terminology used herein is used for the purpose of describing particular embodiments only. The terms are not intended to be limiting unless specified as such.

It must be noted that, as used in this specification and the appended claims, the singular forms “a,” “an,” and “the” include plural referents unless the content clearly dictates otherwise.

The term “self-supporting foam” refers to a foam which can generally retain its shape for a relatively long period of time of at least about 1 minute after being dispensed, e.g., 2 to 10 minutes.

As used herein, the term “fine mesh screen” refers to a screen having mesh sizes of from about 25 microns to about 100 microns. In one embodiment, the screen can have a mesh size of from about 50 microns to about 80 microns.

As used herein the term “alcohol” refers to any compositions containing at least one hydroxyl group (—OH). Non-limiting examples include ethanol, polyol sweeteners, glycerol, combinations thereof, and the like.

The term “skin sanitizer” or “hand sanitizer” refers to compositions of the present invention that are appropriate for application to the skin, such as the hand, for purposes of cleaning, sanitizing, disinfecting, or sterilizing a body surface. This definition does not limit the use of this composition to the hand, but rather, these hand sanitizers can be applied to any exterior body or skin surface. The term “hand sanitizer” merely indicates that these compositions are also appropriate for application to the hands under normal repetitive hand washing circumstances. This term does not limit the use of this material to the hands, as it can be applied to any skin surface with effective results.

When referring to terms like “sanitizing,” “decontaminating,” “sterilizing,” or the like, it is not inferred that complete sanitization, decontamination, sterilization, etc. has necessarily occurred. In other words, partial to complete decontamination or sanitization is included. Likewise, the use of the term “disinfect,” “disinfecting,” “disinfection” does not required for complete disinfection to occur. Generally, though sanitizers, sterilants and disinfectants are used for the same purpose, i.e. to kill bacteria and/or viruses, etc., a sterilant composition exhibits a greater kill level compared to a disinfectant, which in turn has a better kill level than a sanitizer. This being stated, most applications require only sanitizer or disinfectant levels bacteria/virus reduction, though other applications benefit considerably from the use of sterilants. For convenience, in the present application the term “sanitizer” is used generally to refer to each of sanitizer, disinfectant, and sterilant compositions described herein unless the context clearly dictates otherwise.

The term “solution” is also used throughout the specification to describe the liquid compositions of the present disclosure. However, as these “solutions” can include colloidal transition metal(s), these compositions can also be described as dispersions or suspensions. As the continuous phase is typically a solution, and the transition metal is present as a colloid, for convenience, these compositions will typically be referred to as “solutions” herein.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of 1 wt % and about 20 wt %, but also to include individual weights such as 2 wt %, 11 wt %, 14 wt %, and sub-ranges such as 10 wt % to 20 wt %, 5 wt % to 15 wt %, etc.

In accordance with this, a hand sanitizer can comprise from 10 to 1500 ppm of a colloidal transition metal, e.g., colloidal silver, colloidal zinc, colloidal copper, coagulated colloids of multiple colloidal transition metals, etc., from 0.01 wt % to 30 wt % alcohol, at least 70 wt % water, and a thickening agent, e.g., foaming agent, gelling agent, etc. In certain embodiments, the alcohol content is less that 10 wt % and the water content is greater than 90 wt %.

In another embodiment, a hand sanitizer capable can comprise comprises from 10 to 1500 ppm of a colloidal transition metal, e.g., colloidal silver, colloidal zinc, colloidal copper, coagulated colloids of multiple colloidal transition metals, etc., from 0.01 wt % to 10 wt % hydrogen peroxide, from 0.01 wt % to 30 wt % alcohol, at least 70 wt % water; and from 0.01 wt % to 10 wt % of a surfactant. In certain embodiments, the alcohol content is less that 10 wt % and the water is greater than 90 wt %. The hand sanitizer can be capable of providing continued sanitation for a period of at least two hours after initial application.

In one specific embodiment, a foaming hand sanitizer can comprise from 70 wt % to 98 wt % water, from 0.01 wt % to 30 wt % alcohol, from 0.1 wt % to 10 wt % liquid vegetable surfactant, from 0.01 wt % to 5 wt % of a grain extract, from 10 to 500 ppm colloidal silver (or coagulated colloids with other transition metals thereof), and optionally, from 0.01 wt % to 10 wt % hydrogen peroxide.

In each of these embodiments, when the hand sanitizer is dispensed a fine mesh screen, the sanitizer can form a thick self-supporting foam.

It is noted that water comprises at least 70 wt % of the total formulation in many of these embodiments, and often, the water content is greater than 90 wt %. In one embodiment, water comprises at least about 92 wt % to about 98 wt % of the formulation. Similarly, when present in the hand sanitizer, the amount of hydrogen peroxide can also be varied. In one embodiment, the hydrogen peroxide can comprise from 0.01 wt % to 7 wt %. In yet another embodiment, the hydrogen peroxide can comprise from 0.1 wt % to 4 wt % of the formulation. In each of the embodiments of the present disclosure, the amount of colloidal transition metal used in the hand sanitizer can be varied. In one embodiment, it can be from 10 ppm to 1500 ppm. In another embodiment, it can be from about 30 ppm to about 500 ppm. In yet another embodiment, the amount of colloidal transition metal can be from about 50 ppm to about 300 ppm.

Any of a number of colloidal transition metals can be used, including colloidal ruthenium, rhodium, osmium, iridium, palladium, platinum, copper, gold, silver, zinc, alloys thereof, and mixtures thereof. In one embodiment, colloidal silver can be used. In another embodiment, colloidal zinc can be used. In another embodiment, colloidal copper can be used. Also, coagulated colloids of multiple colloidal transition metals can be used, such as silver-zinc coagulated colloids, silver-copper coagulated colloids, zinc-copper coagulated colloids, zinc-copper-silver coagulated colloids, etc. In one specific embodiment, silver-zinc coagulated colloids can be very effective for use.

With specific reference to the colloidal silver that can be used, exemplary colloidal silvers include those sold by Solutions IE, Inc. under the trade names CS Plus and C S Ultra. Other colloidal silver products that can be used as the silver source include ASAP, Sovereign Silver, Silver Max, and the like. In one embodiment, the colloidal particles used in the present disclosure can have a particle size range of from 0.001 μm to 1.0 μm. In still another embodiment the average particle size is 0.35 μm to 0.45 μm.

The amount of alcohol in the embodiments of the present disclosure can also be varied. In one embodiment, the hand sanitizer can include from 0.05 wt % to 30 wt % alcohol or from 0.05 wt % to 10 wt % alcohol. In yet another embodiment, the formulation can include from 0.1 wt % to 6 wt % alcohol of individual alcohols, e.g., 2 wt % to 5 wt % ethanol and/or 2 wt % to 6 wt % glycerol, etc.

As discussed above, the alcohol of the present disclosure can be present in the hand sanitizer in various forms. A wide variety of alcohols, including aliphatic alcohols and other carbon-containing alcohols, having from 1 to 24 carbons (C₁-C₂₄ alcohol) can be used. It is to be noted that “C₁-C₂₄ alcohol” does not necessarily imply only straight chain saturated aliphatic alcohols, as other carbon-containing alcohols can also be used within this definition, including branched aliphatic alcohols, alicyclic alcohols, aromatic alcohols, unsaturated alcohols, as well as substituted aliphatic, alicyclic, aromatic, and unsaturated alcohols, etc. In one embodiment, the aliphatic alcohols can be C₁ to C₅ alcohols including methanol, ethanol, propanol and isopropanol, butanols, and pentanols, due to their availability and lower boiling points. This being stated, polyhydric alcohols can also be used effectively in enhancing the disinfectant or sterilant potency of the compositions of the present disclosure, as well as provide some degree of added stabilization. Examples of polyhydric alcohols which can be used in the present disclosure include but are not limited to sorbitol, maltitol, ethylene glycol (ethane-1,2-diol) glycerin (or glycerol, propane-1,2,3-triol), and propane-1,2-diol. Other non-aliphatic alcohols may also be used including but not limited to phenols and substituted phenols, erucyl alcohol, ricinolyl alcohol, arachidyl alcohol, capryl alcohol, capric alcohol, behenyl alcohol, lauryl alcohol (1-dodecanol), myristyl alcohol (1-tetradecanol), cetyl (or palmityl) alcohol (1-hexadecanol), stearyl alcohol (1-octadecanol), isostearyl alcohol, oleyl alcohol (cis-9-octadecen-1-ol), palmitoleyl alcohol, linoleyl alcohol (9Z, 12Z-octadecadien-1-ol), elaidyl alcohol (9E-octadecen-1-ol), elaidolinoleyl alcohol (9E, 12E-octadecadien-1-ol), linolenyl alcohol (9Z, 12Z, 15Z-octadecatrien-1-ol), elaidolinolenyl alcohol (9E, 12E, 15-E-octadecatrien-1-ol), combinations thereof, and the like.

In some embodiments, for practical considerations, methanol, ethanol, and denatured alcohols (mixtures of ethanol and smaller amounts of methanol, and optionally, minute amounts of benzene, ketones, acetates, etc.) can often be present and useful because of their availability and cost. Alcohols with low boiling points may also be preferred in some embodiments because of their effect on the drying time of the hand sanitizer. Glycerol is also useable in some embodiments. It is noteworthy that some alcohols used in the disclosure can have multiple roles, e.g. sorbitol can function both as an alcohol as well as an emollient.

Emollients can also be used in the hand sanitizing formulations of the present disclosure. As mentioned above sorbitol can be included as an emollient as well as an alcohol. Other emollients can also be used. Other emollients known in the art can also be used.

Humectants can also be included in the hand sanitizing compositions. A variety of humectants including those generally known in the art can be used. In one embodiment, the humectant can be a natural grain extract such as from wheat, oats, flax seed, and combinations thereof. Such natural extracts are particularly advantageous as they generally are less irritable to the skin. In one embodiment, the grain extract is gluten free. In another embodiment, the grain extract is a flax seed extract.

The hand sanitizers of the present disclosure can also include one or more liquid surfactants. Examples of liquid surfactants which can be used include, but are not limited to, liquid vegetable oil soap, sulfonated castor oil, sodium lauryl sulfate or any other liquid surfactant known in the art. In one embodiment, the liquid surfactant includes a liquid vegetable oil soap. In another embodiment, the liquid surfactant includes a sulfonated castor oil. When present in the hand sanitizer formulations, the liquid surfactant(s) can comprise from 0.1 wt % to about 10 wt % of the total sanitizer formulation.

As hand sanitizers are sometimes frequently used by professionals such as healthcare or food handling professionals, it can be desirable to include skin protectants in the hand sanitizer formulations. Examples of skin protectants include, but are not limited to, vitamin E, vitamin E derivatives, aloe vera gel, and combinations thereof. In one embodiment the skin protectant includes vitamin E or a derivative thereof.

As mentioned, in one embodiment of the present disclosure, the hand sanitizer can include a peroxide, such as a metal peroxide or hydrogen peroxide. Alternatively or additionally, a peracid can also or alternatively be included. When present in the hand sanitizer, the peracid can comprise from 0.01 wt % to 5 wt % of the total formulation. The peracid component of the hand sanitizer can be a single compound or a combination of multiple peracid compounds or peracid forming compounds. In one embodiment, the peracid can be any aliphatic or aromatic peracid (or peroxyacid) that is functional for disinfectant purposes in accordance with embodiments described herein. While any functional peracid can be used, peracids containing from 1 to 7 carbons are the most practical for use. These peracids can include, but not be limited to peroxyformic acid, peroxyacetic acid, peroxyoxalic acid, peroxypropanoic acid, perlactic acid, peroxybutanoic acid, peroxypentanoic acid, peroxyhexanoic acid, peroxyadipic acid, peroxycitric, peroxybenzoic acid, and mixtures thereof. The peracid can be prepared using any method known in the art.

When the peracid is prepared from an acid and hydrogen peroxide, the resultant mixture contains both the peracid and the corresponding acid that it is prepared from. For example, in embodiments that utilize peracetic acid, the presence of the related acid (acetic acid) provides stability to the mixture, as the reaction is an equilibrium between the acid, hydrogen peroxide, and the peracid and water, as follows:

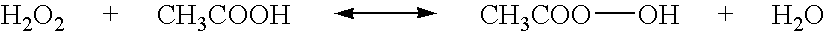

Peracid salts, such as salts of the above listed peracids, can also be included as the peracid component of the hand sanitizer compositions. Non-limiting examples of such salts include permanganates, perborates, perchlorates, peracetates, percarbonates, persulphates, and the like. The salts can be used alone or in combination with each other or other peracid compounds to form the peracid component.

As described above, the hand sanitizers can be formulated to be foams when dispensed from foaming dispensers. Foam dispensers which can be used generally have fine mesh screens which aid in the generation of the foams. The mesh size of the openings on such screens is generally from 25 microns to 100 microns. In one embodiment, the mesh size can be from 50 microns to 80 microns. The foaming sanitizers form thick self-supporting foams which can be readily rubbed onto a skin surface. The self-supporting foams can generally retain their shape after being dispensed for a relatively long period of time of at least about a minute, and often from 2 to 10 minutes.

Whether dispensed as a foam or as a traditional hand sanitizing liquid or gel (with gelling agents), the sanitizers can provide continuous sanitization effects for meaningful periods of time after the initial application of the sanitizer so long as the sanitized area is not scrubbed, wiped, or otherwise washed. In one embodiment, the sanitization effects last for at least 2 hours after the initial application. In another embodiment, the sanitization effects can last for at least 4 hours after the initial application.

The hand sanitizers may also include other excipients and additives which are well known in the art. Non-limiting examples fragrances which can be used include lime oil extract, lemon oil extract, orange oil extract, and the like. Generally, any fragrance can be used so long as it does not have a negative impact on the sanitization effects of the compositions.

These hand sanitizers are generally effective in providing high kill levels against a wide range of pathogens including but not limited to bacteria, spores, viruses, parasites, funguses, and molds. As described, this composition can be used against all of these types of organisms with relative to complete safety to humans and other mammals.

### EXAMPLES

The following examples illustrate the embodiments of the invention that are presently best known. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following examples provide further detail in connection with what are presently deemed to be the most practical and preferred embodiments of the invention.

### Example 1

### Preparation of Hand Sanitizer

A hand sanitizer composition is prepared, which includes the following ingredients in approximate amounts:

95 wt % water

150 ppm colloidal silver

2 wt % ethanol

about 3 wt % gelling or foaming agents

The composition is mixed thoroughly and stored in a suitable container for future use.

### Example 2

### Preparation of Hand Sanitizer

A hand sanitizer composition is prepared, which includes the following ingredients in approximate amounts:

400 ppm colloidal silver

1 wt % ethanol

2 wt % liquid vegetable soap

0.12 wt % sulfonated castor oil

0.015 wt % Vitamin E

Balance water

The composition is mixed thoroughly and stored in a suitable container for future use. Upon ejecting through a 50 to 80 micron screen, the formulation forms a self-supporting foam.

### Example 3

### Preparation of Foaming Hand Sanitizer

A hand sanitizer composition is prepared, which includes the following ingredients in approximate amounts:

94.7 wt % water

2.7 wt % ethanol

2.7 wt % Liquid vegetable surfactant

0.12 wt % sulfonated castor oil

0.1 wt % flax seed extract

0.015 wt % Vitamin E

130 ppm Colloidal silver

0.0004 wt % sorbitol

The composition is mixed thoroughly and is stored in a container capable of dispensing the composition through a 72 micron screen in order to form a self-supporting foam.

### Example 4

### Preparation of a Foaming Hand Sanitizer

A hand sanitizer composition is prepared, which includes the following ingredients in approximate amounts:

91-97.6 wt % water

3-4 wt % ethanol

3-5 wt % glycerol

0.3 to 3 wt % Ammonium Lauryl Sulfate

0.01 to 0.04 wt % Processed Silver

0.01-0.1 wt % Coagulated colloid of Zn—Ag

0.00001 to 0.001 wt % Sorbitol

The composition is mixed thoroughly and is stored in a container capable of dispensing the composition through a 72 micron screen in order to form a self-supporting foam.

### Example 5

### Kill-Time Studies Using the Hand Sanitizer of Example 4

A study was conducted to determine the antimicrobial activity of the colloidal silver-containing hand sanitizer of Example 4, when challenged with an organic load, on the test organism Staphylococcus aureus.

This was accomplished by performing a standard suspension test on the hand sanitizer. A one minute contact time was used.

Specifically, the test suspension was prepared by growing a 5 ml culture of Staphylococcus aureus, ATCC 6538, in Trypticase Soy Broth at 37° C., for 20 hours. Five (5) ml of culture was pelleted by centrifugation, washed with 5 ml sterile 18 MΩ water, centrifuged again, and resuspended in a final volume of 5 ml sterile water.

A neutralizer was prepared that included 9 ml tubes of 12.7 wt % Tween 80 (surfactant), 6.0 wt % Tamol, 1.7 wt % lecithin, 1 wt % peptone, and 0.1 wt % cystine and 500 mM Tris (pH 7.0).

The “Kill Time” procedure followed was as follows: A 9.9 ml aliquot of the disinfectant of Example 4 was placed in a 50 ml polypropylene sterile centrifuge tube, and the tube was equilibrated in a 20° C. water bath. The tube of hand sanitizer was inoculated with 100 μl of the S. Aureus suspension at time zero. After 1 minute, 1 ml of the organism/hand sanitizer suspension was removed to 9.1 ml of neutralizer. The tube was mixed thoroughly. After 2 minutes, the neutralized suspension was serially diluted (1:1×10, 1:1×10², 1:1×10³, etc.) in physiological saline solution (PSS). The number of viable organisms in selected dilution tubes was assayed by membrane filtration. One (1) ml aliquots were plated in duplicate, and the membranes were washed with about 100 ml of sterile PSS and removed to Columbia agar plates. The plates were incubated at 37° C. for 24 and 48 hours. The number of colonies on each filter was counted and log reduction and percent kill values were computed.

As a control, a titer (or measurement of the amount or concentration of a substance in a solution) of the test suspension was computed by performing membrane filtration assays of selected 1:10 dilutions of the test suspension in PSS. A neutralizer control was performed by inoculating a mixture of 9 ml of neutralizer and 1 ml of disinfectant with 100 μl of the 1:10⁵ dilution of the titer. This produced about 305 CFU/ml in the tube, which was allowed to stand for 20 minutes prior to dilution and assay of the tubes by membrane filtration using duplicate 1 ml samples. Sterilization controls were performed by filtering 100 ml (PSS) or 1 ml (other fluids) samples of each solution used in this testing. Plates were incubated as above.

The results are provided as follows:

TABLE 1a
Titer

| | Dilution | | |
|---|---|---|---|
| | 1:1 × 10⁶ | 1:1 × 10⁷ | 1:1 × 10⁸ |
| Number of | TNC* | 37 | 4 |
| Colonies | TNC | 30 | 4 |

*TNC—Too Numerous to Count

TABLE 1b
Hand Sanitizer solution (Example 4)
Dilution of staphylococcus/disinfectant suspension

| | Dilution | | |
|---|---|---|---|
| | 1:1 × 10¹ | 1:1 × 10² | 1:1 × 10³ |
| 1 Minute | 0 | 0 | 0 |
| | 0 | 0 | 0 |

TABLE 1c
Neutralization control

| | Dilution | | | |
|---|---|---|---|---|
| | Control | | | Percent of |
| | 1:10 | undiluted | 1:1 × 10¹ | Expected |
| 1 minute | 32 | 305 | 30 | 82 |
| | 17 | | | |

Results of the titer showed a viable staphylococcus aureus concentration of 3.35×10⁸ organisms per ml in the original suspension. Inoculation of 9.9 ml of disinfectant with 100 μl of this suspension produced an initial concentration of 3.35×10⁶ organisms per ml in the assay tube. Results from these procedures allowed log reduction (LR) and percent kill (PK) values to be calculated using the formulas: 1) LR=−Log(S/S°) where S=concentration of viable organisms after 45 minutes; and S°=the initial concentration of viable organisms at time zero; and 2) PK=(1−(S/S°))×100. These values are shown below.

TABLE 2
Results

| | Contact | | |
|---|---|---|---|
| Solution | Time | Log Reduction (LR) | Percent Kill (PK) |
| Disinfectant solution | 1 minute | >5.83 | >99.99985 |
| of Example 4 | | | |

The neutralization control data indicated that the test solution was adequately neutralized. Observed counts were slightly greater than those expected, indicating no residual killing took place due to un-neutralized disinfectant. In general, the disinfectant solution tested here had high antimicrobial activity against Staphylococcus aureus.

While the invention has been described with reference to certain preferred embodiments, those skilled in the art will appreciate that various modifications, changes, omissions, and substitutions can be made without departing from the spirit of the invention. It is therefore intended that the invention be limited only by the scope of the appended claims.

What is claimed is:

1. A hand sanitizer, comprising:
a) from 10 to 1500 ppm by weight colloidal transition metal;
b) from 0.01 wt % to 30 wt % alcohol;
c) at least about 70 wt % water; and
d) a thickening agent.

2. The hand sanitizer of claim 1, including the thickening agent is a foaming agent, and wherein the hand sanitizer as a whole is formulated to form a foam when ejected through a screen having from 10 to 100 micron mesh size.

3. The hand sanitizer of claim 1, wherein the alcohol comprises from 0.05 wt % to about 10 wt % of the hand sanitizer.

4. The hand sanitizer of claim 1, wherein the alcohol is selected from the group consisting of ethanol, sorbitol, glycerol, and combinations thereof.

5. The hand sanitizer of claim 1, wherein the hand sanitizer includes from 0.1 wt % to 7 wt % of a peroxygen.

6. The hand sanitizer of claim 5, wherein the peroxygen is hydrogen peroxide.

7. The hand sanitizer of claim 5, wherein the wherein the peroxygen is a peracid.

8. The hand sanitizer of claim 1, wherein the colloidal transition metal includes colloidal silver.

9. The hand sanitizer of claim 1, wherein the colloidal transition metal has an average particle size of from 0.001 μm to 1.0 μm.

10. The hand sanitizer of claim 1, wherein the hand sanitizer includes a grain extract.

11. The hand sanitizer of claim 9, wherein the grain extract is selected from the group consisting of wheat extract, oat extract, flax seed extract, and combinations thereof.

12. The hand sanitizer of claim 1, wherein the sanitizer includes a liquid surfactant.

13. The hand sanitizer of claim 12, wherein the liquid surfactant includes a liquid vegetable oil soap.

14. The hand sanitizer of claim 12, wherein the liquid surfactant comprises from 0.1 wt % to 10 wt % of the hand sanitizer.

15. The hand sanitizer of claim 1, wherein the sanitizer includes an emollient.

16. The hand sanitizer of claim 16, wherein the emollient is sorbitol.

17. The hand sanitizer of claim 1, wherein the thickening agent is a gelling agent.

18. The hand sanitizer of claim 1, wherein colloidal transition metal is a coagulated colloid including at least two transition metals.

19. The hand sanitizer of claim 18, wherein at least one colloid of the coagulated colloid is silver.

20. The hand sanitizer of claim 18, wherein at least one colloid of the coagulated colloid is zinc.

21. The hand sanitizer of claim 18, wherein the coagulated colloid includes a silver-zinc coagulated colloid.

22. The hand sanitizer of claim 1, wherein the hand sanitizer provides for continued sanitization effects for at least 2 hours after initial application.

23. A foaming hand sanitizer, comprising:
a) from 70 wt % to 99 wt % water;
b) from 0.01 wt % to 30 wt % alcohol;
c) from 0.1 wt % to 10 wt % surfactant; and
d) from 10 to 1500 ppm colloidal transition metal,
wherein upon dispensing though a screen fine mesh screen, the sanitizer forms a thick self-supporting foam.

24. The foaming hand sanitizer of claim 23, wherein
i) from 0.01 wt % to 7 wt % of a peroxygen is present; or
ii) from 0.01 wt % to 5 wt % of a grain extract is present;
iii) the surfactant is a liquid vegetable surfactant; or
iv) the colloidal transition metal includes a coagulated colloid of zinc and silver.

25. The foaming hand sanitizer of claim 24, wherein at least two of i), ii) iii) and iv) are present in the foaming hand sanitizer.
